(19) United States
(12) Patent Application Publication
(10) Pub. No.: US 2021/0081206 A1
(43) Pub. Date: Mar. 18, 2021

(54) PROGRAMMABLE ELECTRONIC DEVICES AND METHODS OF OPERATING THEREOF

(71) Applicant: STMicroelectronics (Grenoble 2) SAS, Grenoble (FR)

(72) Inventor: Pascal Gouedo, St Jean de Moirans (FR)

(21) Appl. No.: 17/021,819

(22) Filed: Sep. 15, 2020

(30) Foreign Application Priority Data
Sep. 16, 2019 (FR) 1910189

(51) Int. Cl. G06F 9/38; G06F 9/30; G06F 12/02; G06F 11/30

(52) U.S. Cl. CPC G06F 9/3812; G06F 9/30047; G06F 11/3037; G06F 12/0246; G06F 9/30043

(57) ABSTRACT

An embodiment method comprises selecting memory zones from a position of instructions of a program, the instructions each occupying one or more memory locations, and the zones comprising, for each memory location, a same number of bits, preferably equal to one or two.

### CROSS-REFERENCE TO RELATED APPLICATIONS

This application claims the benefit of French Application No. 1910189, filed on Sep. 16, 2019, which application is hereby incorporated herein by reference.

### TECHNICAL FIELD

The present disclosure relates generally to programmable electronic devices, and methods for executing instructions of a program.

### BACKGROUND

A program is made up of a sequence of instructions. The instructions are for example stored in a memory coupled to a sequential data processing unit such as a microprocessor. Upon executing the program, instructions can be executed a plurality of times, for example when the program comprises a loop. Other instructions may not be executed, for example following a branch instruction; that is to say, an instruction may indicate a part of the program to be executed after the branch instruction.

### SUMMARY

There is a need to know which instructions of the program are executed and which instructions are not executed during the implementation of the program.

One embodiment addresses all or some of the drawbacks of typical programmable electronic devices and typical methods for executing instructions of a program.

One embodiment makes it possible to reduce the size of an information storage memory making it possible to determine which instructions have been executed during an implementation of the program.

One embodiment provides a method comprising a step for selecting memory zones from a position of instructions of a program, the instructions each occupying one or more memory locations, and the zones comprising, for each memory location, a same number of bits, preferably equal to one or two.

According to one embodiment, the method comprises the execution of at least one part of the instructions and, for each executed instruction, the storage of a value in one of the zones selected from the position of the executed instruction.

According to one embodiment, each of the zones comprises at least one first bit and at least one second bit, the bits comprising the value one in the location of the first bit if the executed instruction has a predicate to the value “true,” the value one in the location of the second bit if the executed instruction has a predicate to the value “false,” or the value one in the locations of the first and second bits if the executed instruction is not an instruction with predicate.

According to one embodiment, the storage is done in parallel with the execution.

According to one embodiment, the storage is done simultaneously for instructions executed simultaneously.

According to one embodiment, the method comprises, after the execution, a step for verifying the presence of the value in each of the zones and/or detecting the absence of the value in one of the zones.

According to one embodiment, the storage comprises the writing, in a memory word location comprising at least one of the zones, of a word having, outside the at least one of the zones, the content of the memory word location before the writing.

According to one embodiment, the zones are located in at least two distinct memory banks.

According to one embodiment, the memory word location has least significant bits located in one of the two banks and most significant bits located in the other of the two banks.

Another embodiment provides a device configured to implement a method as defined hereinabove.

Another embodiment provides an integrated circuit comprising a device as defined hereinabove.

According to one embodiment, the circuit comprises the zones and is configured to execute the instructions.

According to one embodiment, the circuit is configured to be coupled to a memory outside the circuit and to transmit the content of the zones to the outside memory.

Another embodiment provides a device comprising the outside memory of a circuit as defined hereinabove, the device being configured to receive the contents of the zones and to write the contents of the zones in the outside memory.

According to one embodiment, the device is configured to verify the presence of the value in the content of each of the zones and/or the detection of the absence of the value in one of the contents.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 shows, schematically and in block diagram form, an embodiment of a system comprising a programmable device;

FIG. 2 shows, through a partial and schematic view of two memories, an embodiment of a method implemented during the execution of instructions of a program;

FIG. 3 shows, schematically and in block diagram form, an embodiment of a programmable device;

FIG. 4 shows, schematically and in block diagram form, another embodiment of a system comprising a programmable device;

FIG. 5 shows, through a partial and schematic view of two memories, another embodiment of the method of FIG. 2; and

FIG. 6 shows, through a partial and schematic view of two memories, another embodiment of the method of FIG. 2.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, units of a programmable device, such as a data processing unit, are not disclosed in detail, the disclosed embodiments being compatible with such typical units.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front,” “back,” “top,” “bottom,” “left,” “right,” etc., or to relative positional qualifiers, such as the terms “above,” “below,” “higher,” “lower,” etc., or to qualifiers of orientation, such as “horizontal,” “vertical,” etc., reference is made to the orientation shown in the figures.

Unless specified otherwise, the expressions “around,” “approximately,” “substantially” and “in the order of” signify within 10%, and preferably within 5%.

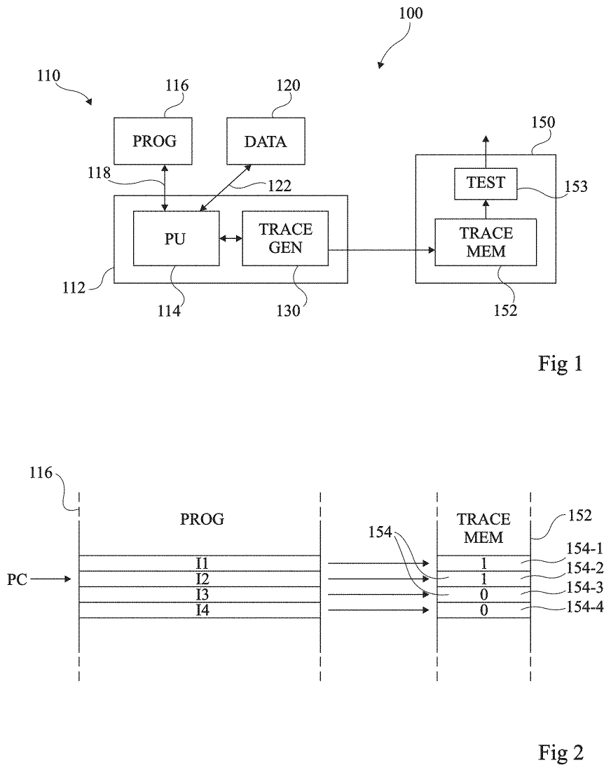

FIG. 1 shows, schematically and in block diagram form, an embodiment of a system 100 comprising a programmable device 110. The device 110 may comprise, or be constituted by, a circuit of the field programmable gate array (FPGA) type, or by gates of the ASIC type (Application-Specific Integrated Circuit).

The programmable device 110 is for example used in an automotive application. The programmable device 110 can then be comprised in an assembly such as an antilock brake system, or a driving assembly of a motor vehicle. The programmable device can also be used in applications such as data acquisition and the viewing of the detected data, or for example laser distance measurement applications.

The programmable device 110 comprises a program execution circuit 112. The circuit 112 is preferably an integrated circuit. In a variant, the circuit 112 comprises a plurality of distinct integrated circuits. An integrated circuit is defined by a package containing one or more chips (“die”). A chip, or microchip, refers to a semiconductor wafer portion and electronic circuits located in and on the wafer. The package comprises connector surfaces or electrically conductive pins coming out of the package. The surfaces or pins are configured for being electrically coupled to other circuits, preferably welded on a printed circuit board (PCB). Preferably, the circuit 112 comprises a single chip.

The circuit 112 comprises a data processing unit (PU) 114. The circuit 112 is coupled, preferably connected, by a link with a connection 118, to a memory 116 (PROG) of the device 110. The memory 116 contains the instructions of the program. According to the illustrated example, the memory 116 is outside the circuit 112. “Outside” means that the device 110 is manufactured by providing, separately, the memory 116 and the circuit 112 configured to be coupled, preferably connected, to the memory 116. According to one preferred example, the memory 116 is in the internal memory of the circuit 112, that is to say, the memory 116 is comprised in the package of the integrated circuit, and preferably on the same chip as the circuit 112. For example, the memory 116 is of the type referred to as tightly coupled memory (TCM). In one preferred example, the program memory 116 contains 64-bit words and the link 118 is a 64-bit link in parallel. A word of a memory refers to a binary value whose bits are accessible simultaneously in read or in write mode in a memory.

Preferably, the circuit 112 is coupled, preferably connected, by a link with a connection 122, to a memory 120 (DATA) of the device 110. The memory 120 can be outside the circuit 112, or preferably inside the circuit 112. The memory 120 can be of the TCM type. Preferably, the memories 116 and 120 are two separate memory banks, preferably of the TCM type. The links 118 and 122 are then preferably separate. The memories 116 and 120 can also be parts of a same memory bank, and the links 118 and 122 are then a same link. In one preferred example, the data memory 120 contains 32-bit words and the link 122 is a 32-bit link in parallel.

The circuit 112 further comprises a unit 130 (TRACE GEN) configured to generate a trace of the program. A trace of the program refers to a set of information making it possible to distinguish between the instructions not yet having been executed and the instructions having been executed by the program. The trace of the program is generated during the execution of the program. The trace then makes it possible to distinguish between the instructions not having been executed and the instructions already having been executed by the program.

The system 100 further comprises a device 150 coupled, preferably connected, to the device 110. The device 150 makes it possible to test the operation of the device 110 before the latter is used in an application. The device 150 can be a test platform, or a development platform of the programmable device 110. As an example, the device 150 further makes it possible to program the programmable device 110. According to one embodiment, the device 150 comprises a memory 152 (TRACE MEM) configured to receive the trace. The memory 152 is then outside the circuit 112. The device 150 can further comprise a circuit 153 (TEST) coupled, preferably connected, to the memory 152. The circuit 153 preferably comprises a unit for executing software (that is to say, another program) for testing the program contained in the memory 116. Such a unit can comprise a microprocessor. In a variant, the circuit 153 makes it possible to transmit, for example by a communication network, the content of the memory 152 to another circuit, not shown, configured to implement the test software.

The device 110 and/or the device 150 can further comprise a debugger unit, not shown, typically configured to allow the execution of the program step by step and/or to generate information regarding the value of variables of the program and/or to establish stopping points in the program.

During operation, the program is implemented once, or a plurality of times, preferably with different data values used by the program. The instructions of the program are executed by the unit 114. The trace is generated by the unit 130 during the implementation(s) of the program. The obtained trace is stored in the memory 152. From the trace stored in the memory 152, the circuit 153 determines, for example by implementing the test software, whether some of the instructions have not been executed during the implementation of the program, and optionally, if applicable, which instructions these are.

FIG. 2 shows, through a partial and schematic view of the program 116 (PROG) and trace storage 152 (TRACE MEM) memories of the device of FIG. 1, an embodiment of a method implemented during the execution of instructions of the program. In particular, the execution is implemented by the circuit 112. More specifically, the program is executed one or more times and the circuit 130 generates the trace in the manner described in relation with FIG. 1.

The memory 116 comprises the successive instructions I of the program. Four instructions I (I1, I2, I3 and I4) are shown as an illustration, but the described embodiments apply to any number of instructions of the program.

The unit 114 typically comprises a program counter PC, also called instruction pointer or ordinal counter. The program counter PC here designates a register that contains the memory address of the beginning of the instruction being executed. However, in a variant, this register may contain the memory address of the beginning of the instruction to be executed after the instruction being executed. In the illustrated example, the program counter PC contains the memory address of the beginning of the instruction I2.

Memory zones 154 (154-1, 154-2, 154-3, 154-4), each made up of one or more bits of the memory 152, are selected from positions of the instructions I. Positions of the instructions refer to values having the same order as those of the instructions in the memory 116. Thus, memory zones 154 are determined as a function of the positions of the instructions in the memory. One has thus associated one of the zones 154 with each instruction I of the program. Separate instructions correspond to separate and disjointed zones 154. Preferably, as shown, the zones 154 are placed in the memory 152 in the same order as the instructions I in the memory 116. This is not limiting, the zones 154 being able to be placed in a different order.

The position of each instruction can be defined by the memory address of the beginning of the instruction. During the execution of the program, each memory zone 154 can then be selected as a function of the memory address of the beginning of the executed instruction. In other words, the memory address of the beginning of the zone 154 associated with the executed instruction can be determined from the program counter PC.

Preferably, before the implementation(s) of the program making it possible to generate the trace, the trace memory 152 is filled with first values, more preferably a same first value, for example a low logic level (0). This is not limiting, the first values being able to be the values initially contained in the trace memory.

Preferably, for each executed instruction, a second value is stored that is different from the first value. In the example of a first value with a low logic level, the second value preferably has a high logic level (1). Thus, the zones 154 associated with the instructions I not yet executed (in the illustrated example, the zones 154-3 and 154-4 associated with the instructions I3 and I4) contain the first value. The zones 154 associated with the instructions I already executed (in the illustrated example, the zones 154-1 and 154-2 associated with the instructions I1 and I2) contain the second value. In particular, the zones 154 associated with instructions I already having been executed a plurality of times contain the second value. This is not limiting, in particular it is possible to use a plurality of second values different from the first value for various executions of the instruction.

Preferably, after the trace has been obtained, for each of the zones 154 associated with at least part of the program, the circuit 153, for example by executing the test software, verifies whether the zone 154 contains the or one of the second values, or detects whether the zone 154 contains the first value. If one of the zones 154 contains the first value, this means that the associated instruction has not been executed. The circuit 153 thus detects, if applicable, the presence of non-executed instructions.

One could have thought to obtain a trace by recording the successive positions of the program counter PC. However, because of the fact that the instructions are repeated, the trace thus recorded would have taken up much more space in the memory, for example a plurality of gigabytes, than that occupied by the trace obtained by the method described hereinabove.

By comparison, obtaining a trace in memory zones selected from positions of the program instructions makes it possible to limit the size of the trace. In particular, one avoids having to copy the address of the executed instruction in the storage memory of the trace. Thus, the size of the trace can be smaller, for example, than 100 kilobytes, or even 10 kilobytes. More specifically, the size of the trace depends only on the size of the program, and does not depend on the execution duration of the test. In one example, the size of the trace is equal to one eighth of that of the program. One has thus advantageously obtained a trace storage memory 152 having a size considerably smaller than that of the storage memories for traces obtained by recording the successive positions of the executed instructions.

Preferably, the program is designed such that all of the instructions of the program are executed. This makes it possible in particular to prevent non-executed parts of the program from being able to constitute points of entry for an attack or risking causing the program to engage in an unknown behavior. Such an attack would for example aim to cause the execution of another program allowing the attacker to take control of the device 110. In order to verify that in practice, all of the instructions of the obtained program are executed, typically one or more validation tests are provided in which it is necessary to verify that 100% of the instructions are executed when the program is executed during the test(s) with predefined data used by the program.

The circuit 153 then makes it possible to verify that all of the instructions of the obtained program have in practice been executed. Thus, the trace obtained by the method described hereinabove allows the device to pass the validation test successfully.

Preferably, for at least part of the program, the instructions I are associated bijectively with the selected zones 154, that is to say, each selected zone 154 is associated with one and only one instruction I. If one or more zones 154 are detected that are associated with one or more non-executed instructions, this makes it possible to identify the non-executed instruction(s) from this or these zones 154. This makes it possible for the non-executed instruction(s) to be signaled by the circuit 153. The information regarding the non-executed instruction(s) can for example be used to modify the program, or to modify the test(s) or to define new tests, such that all of its instructions are executed after modification. This information can also be used to determine an attack or unknown behavior risk level of the program due to the non-executed instructions.

Preferably, the zones 154 are adjacent in the memory 152. Thus, the zones 154 associated with the instructions correspond to a continuous range, or to all, of the memory 152. Relative to a variant in which the zones 154 are separated by spaces, this makes it possible, once the trace is obtained, for all of the zones of the range containing the first value to correspond to a non-executed instruction. Thus, the detection of the non-executed instructions is facilitated relative to separate zones 154.

Preferably, the storage of the trace is done parallel to the executions of the instructions, that is to say, for each executed instruction, the selection of the zone 154 and the storage of the second value in the memory 152 are done during the execution of the instruction. This advantageously makes it possible to obtain the trace without slowing the execution of the program.

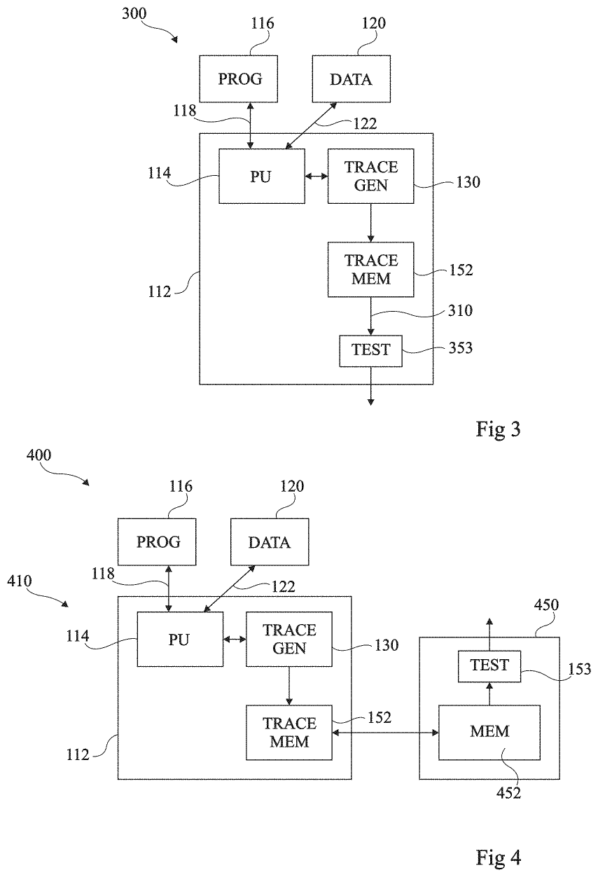

FIG. 3 shows, schematically and in block diagram form, an embodiment of a programmable device 300. The device 300 comprises elements identical or similar to those of the system 100 of FIG. 1, coupled identically or similarly. These elements are not described here again, and only the differences are highlighted.

The device 300 comprises the elements of the device 110 of FIG. 1, namely the memories 116 and 120 and the units 114 and 130 comprised in the circuit 112. The programmable device 300 differs from the programmable device 110 of FIG. 1 in that the integrated circuit 112 comprises the memory 152 and a circuit 353 (TEST). The circuit 353 replaces the circuit 153 of FIG. 1 and is configured to implement all or some of the functions of the circuit 153.

As mentioned hereinabove, the memory 152 has a reduced size. This has the advantage of facilitating the integration of the memory 152 into the integrated circuit 112. Such a memory 152 internal to the circuit 112 makes it possible, relative to an external memory like that of FIG. 1, to simplify the writing of data, in particular to do without a clock outside the device 110 (FIG. 1) configured to synchronize the writing of the trace in the memory 152. This also makes it possible to avoid the risk of losing part of the trace for example following synchronization problems and/or cluttering of the link between the circuit 130 and the memory 152. Such cluttering may for example occur if this link comprises a link bus between a plurality of electronic devices. This also advantageously makes it possible to reduce the number of pins on the package of the integrated circuit 112, since the link between the circuit 130 and the memory 152, allowing the transfer of a plurality of bits in parallel, is then a link 310 internal to the integrated circuit 112.

The storage of a trace in parallel with the execution of the instructions of the program can be done outside a validation test of the program, for example during the operation of the programmable device 300 in an application. This has the advantage of making it possible to monitor the operation of the program implemented in the application. The fact that the memory 152 is internal to the circuit 112 makes it possible to simplify the obtainment of the trace of the program when it is implemented in the application.

FIG. 4 shows, schematically and in block diagram form, another embodiment of a system 400 comprising a programmable device 410. The system 400 further comprises a device 450. The devices 450 and 410 comprise elements of the system 100 of FIG. 1, coupled identically or similarly. These elements are not described here again, and only the differences are highlighted.

The device 450 corresponds to the device 150 of FIG. 1, wherein the memory 152 has been replaced by a memory 452 (MEM) configured for receiving the obtained trace and storing this trace. In particular, for each of the zones 154 of the memory 152 associated with at least part of the program, the circuit 153 of the device 450 verifies whether a zone of the memory 452 corresponding to the zone 154 contains the or one of the second values, or detects whether this zone of the memory 452 contains the first value.

The programmable device 410 comprises the elements of the device 110 of FIG. 1, namely the memories 116 and 120 and the units 114 and 130 comprised in the circuit 112. The programmable device 410 differs from the programmable device 110 of FIG. 1 in that the integrated circuit 112 comprises the memory 152. The device 410 is configured to be coupled to the memory 452, outside the device 410. The device 410 is configured in order, once coupled to the memory 452 and once the trace is obtained, to transmit the trace, that is to say, the content of the zones 154 (FIG. 2), to the memory 452.

The device 450 can have the same functionalities as the device 150 of FIG. 1. Furthermore, because the memory 152 is internal to the circuit 112, one has the benefit of the advantage, mentioned in relation with FIG. 3, of avoiding the risk of losing part of the trace following synchronization and/or cluttering problems. One therefore benefits both from this advantage and the functionalities of a test platform.

In a variant, the device 450 further comprises the circuit 353 of the device 300 of FIG. 3.

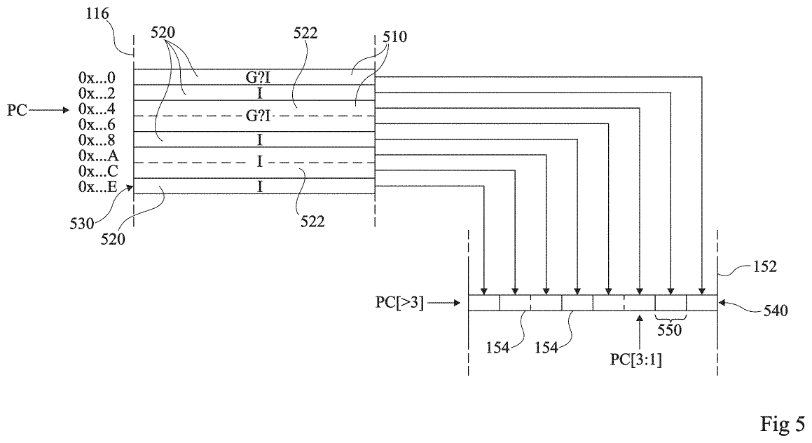

FIG. 5 shows, through a partial and schematic view of an embodiment of the program 116 and trace storage 152 memories of the device of FIG. 1, another embodiment of the method of FIG. 2.

The memory 116 comprises successive memory locations 510. Memory locations refer to separate parts of a memory each having a predefined number of bits, in other words, a predefined size. All of the locations preferably have the same size. Eight successive locations 510 are shown.

The size of the locations 510 is preferably chosen so that the size of each instruction, that is to say, the number of bits occupied by the instruction in the memory 116, is a multiple of the size of the locations 510. In the illustrated example, instructions 520 occupy a single location 510, and instructions 522 occupy two locations 510. Instructions can occupy a number of locations 510 greater than two. In the illustrated example, the size of the locations is sixteen bits.

The locations form groups 530 of locations, a single group 530 being shown. The successive groups 530 have the same number of locations, eight locations in the illustrated example. The locations of each group 530 are positioned at respective addresses. In the illustrated example, these addresses, expressed in bytes, have values 0x . . . 0, 0x . . . 2, 0x . . . 4, 0x . . . 6, 0x . . . 8, 0x . . . A, 0x . . . C, and 0x . . . E, where the prefix “0x” means that the following digits are in hexadecimal notation, and “ . . . ” means that the figures not described in detail depend on the considered group 530. The program counter PC has further been shown when an instruction positioned at the address 0x . . . 4 is executed.

The trace storage memory 152 comprises locations 540. A single location 540 is shown. Preferably, the locations 540 are memory word locations, that is to say, each location 540 has the size of a word of the memory 152. In the illustrated example, each location 540 has a size of sixteen bits. Thus, the address of the location 540 in the memory 152 is shown by the value of the bits PC[>3] of the program counter PC with rank strictly greater than three, the ranks of the bits being defined starting from zero from the least significant bit.

Each zone 154 of the memory 152 is at least partly comprised in one of the locations 540. The zones 154 selected from instructions occupying a same group 530 of the memory 116 occupy a same location 540 of the memory 152. More specifically, for each instruction, the zone 154 associated with the instruction comprises a same number N of bits for each of the locations 510 occupied by the instruction. In other words, the zone 154 comprises, for each location, a subpart 550 with N bits. Thus, for each instruction, the size of the associated zone 154 is the result of the multiplication of the number N by the number of locations occupied by the instruction. In an example that is not shown, the number N is equal to one. In the illustrated example, the number N is equal to two. Thus, in the illustrated example, the position of the zone 154 in the location 540 is defined by the three least significant bits PC[3:1] of the program counter PC.

In a variant, the zones 154 selected from instructions of different sizes have the same number of bits. However, relative to such a variant, providing a same number of bits N of the zones 154 for each location 510 makes it possible to simplify how the zones 154 are selected from positions of the instructions, as illustrated in the example above of the use of the bits of the counter PC.

Preferably, when an instruction occupying a plurality of locations is executed, the value written in the zone 154 comprises same bits in each of the subparts 550. In other words, same bit values are written in the subparts 550 of the zone 154. For example, in the case of subparts 550 with a single bit and contents of the memory 152 with the nil value before execution of the program, all of the bits of the zone 154 are set to the value one.

In a variant, a value is written only in one of the subparts 550 of the zone 154, for example a least significant subpart of the considered zone 154. However, relative to such a variant, writing the same bits in the subparts 550 makes it possible to prevent parts of the memory 152 containing the nil value from in fact corresponding to locations of executed instructions. One thus facilitates the use of the trace to detect the non-executed instructions.

To write a value in the zone 154 associated with the executed instruction, a word is written in the location 540 comprising, outside the considered zone 154, the content of the location 540 before writing. Thus, outside the zone 154 associated with the executed instruction, the content of the location 540 is not modified during this writing. This allows the value in the considered zone 154 to be written without modifying the contents of the other zones 154. To that end, in the case where the content of the location 540 is at the nil value before execution of the program, the memory 152 is for example configured so that only non-hidden bits are written in each of the locations. It is possible to use a mask having nil bits outside the bits to be written. The writing is then done by using a word containing nil bits outside the considered zone 154, and using the word to be written as mask. Preferably, the memory is configured so that only the bits having the non-nil value are written in the considered location 540, the other locations being left at the nil value. In a variant, it is possible to implement an OR function bit by bit with the content of the location 540 before writing. The word used thus also plays the role of a mask. However, relative to such a variant, the use of a memory in the manner described hereinabove allows access to the memory in read mode to be avoided, and therefore allows the desired value in the zone 154 to be written more quickly.

According to one embodiment, a plurality of instructions of a same group are executed simultaneously. One then writes a word comprising, outside the zones 154 associated with these instructions, the content of the location 540 before writing. Preferably, each word location 540 comprises a plurality of zones 154. This makes it possible to write simultaneously in all of the zones 154 associated with the instructions executed simultaneously. It is thus easily possible to obtain the trace simultaneously with the execution of the program.

Although word locations 540 have been shown with sixteen bits, the disclosed embodiments are compatible with other sizes of the locations 540. The number of locations 510 of each group 530 is then defined as a function of the size of the locations 540 and the number N, such that the zones 154 associated with the instructions of a same group completely occupy a single location 540. In particular, in one preferred embodiment, different from the illustrated example, each location 540 has 32 bits, and each group 530 has 16 locations.

For some of the instructions (G?I), the execution of the instruction can depend on the Boolean value of a predicate, also called guard. The instruction is then called predicated instruction or guarded instruction. Such predicated instructions for example make it possible for the execution of parts of the program to depend on conditional test results, without this affecting conditional jumps between parts of the program. For other instructions of the program (I), the execution does not depend on a predicate.

In the case of a program comprising predicated instructions, it is preferred for the number N to be equal to 2, like in the illustrated example. The value written in the zone 154 associated with an executed instruction therefore comprises, for each subpart 550, first and second bits, for example a least significant bit and a most significant bit. Preferably, the first bit is set to the value one if the predicate is at the value “true,” and the second bit is set to the value one if the predicate is at the value “false.” Preferably, for a non-predicated instruction, the first and second bits are both set to the value one.

Preferably, to write the value in the zone 154, a word is written in the location 540 comprising, outside bits set to the value one, the content of the location 540 before writing. To that end, preferably, the content of the location after writing results from an OR function bit by bit between the content of the location before writing and a mask comprising bits at the value zero outside bits to be set to the value one.

Because the subparts 550 are made up of two bits, it is possible to obtain a trace making it possible to distinguish between the instructions not having been executed, the instructions having been executed only for their predicate at the value “true,” the instructions having been executed only for their predicate at the value “false,” and the instructions having been executed for both values of their predicate. It is possible, at the same time, to benefit from advantages of the predicated instructions, such as a gain in speed in the execution of certain loops of the program and a simplification of the management of conditional branches of the program.

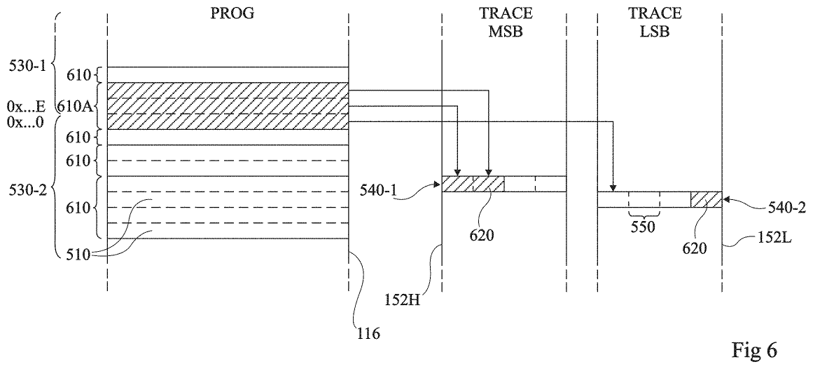

FIG. 6 shows, through a partial and schematic view of an embodiment of the program 116 and trace storage 152 memories of the device of FIG. 1, another embodiment of the method of FIG. 2. The embodiment of FIG. 6 reiterates elements, identical or similar, to those of the embodiment of FIG. 5. These elements are not described in detail here again, and only the differences are highlighted.

The memory 152 comprises two distinct memory banks 152H (TRACE MSB) and 152L (TRACE LSB). More preferably, the banks 152H and 152L respectively correspond to most and least significant bits of the locations 540 of the memory 152. Like in FIG. 5, an example location 540 of eight bits has been shown. However, the locations 540 preferably have 16 bits.

Like in the embodiment of FIG. 5, the program can comprise instructions of a plurality of different sizes, for example 16, 32 and 48 bits, occupying a plurality of locations 510 of the program memory 116. Furthermore, instructions can be executed in parallel. In other words, parts 610 of the program memory 116 each comprise one or more locations 510, and, in each part 610 comprising a plurality of instructions, the instructions are executed at the same time. Each part 610 is then associated with one or more zones 154 of the memory 152 in which one wishes to write values simultaneously.

Shown, among the parts 610, are a part 610A located straddling separate groups 530 (530-1 and 530-2) of locations 510 of the memory 116. The zone(s) 154 associated with the part 610A are in a part 620 of the memory 152 located straddling separate locations 540 (540-1 and 540-2).

The bits of the part 620 located in the location 540-1 are located in the bank 152H and the bits of the part 620 located in the location 540-2 are located in the bank 152L. Because these banks are separate, values can be written corresponding to the zones 154 associated with the part 610A being executed simultaneously in the separate locations 540-1 and 540-2.

Relative to the embodiment of FIG. 5, performing the storage simultaneously in the separate locations 540-1 and 540-2 makes it possible to avoid performing the two storage operations sequentially while the instructions of the part 610A are executed. It is thus advantageously possible to use memories that are not as fast as the memory 152 and/or it is not necessary to provide that the program does not contain a part 610A straddling two groups 530 of locations 510.

Although an embodiment comprising two memory banks has been described, this embodiment is compatible with a larger number of memory banks, each comprising differently significant among the bits of the locations 540.

Various embodiments and alternative embodiments have been described. Those skilled in the art will understand that certain features of these embodiments can be combined and other variants will readily occur to those skilled in the art.

Finally, the practical implementation of the embodiments and alternative embodiments described herein is within the capabilities of those skilled in the art based on the functional description provided hereinabove.

What is claimed is:

1. A method comprising:
selecting memory zones from respective positions of instructions of a program,
the instructions each occupying one or more memory locations, and
the memory zones comprising, for each memory location, a same number of bits.

2. The method according to claim 1, further comprising:
executing at least a subset of the instructions; and
for each executed instruction, storing a value in one of the memory zones selected from the respective position of the executed instruction.

3. The method according to claim 2, wherein each of the memory zones comprises at least one first bit and at least one second bit, the at least one first and at least one second bits comprising:
storing one as the value in a location of the first bit based on the executed instruction having a predicate to a value “true”;
storing one as the value in a location of the second bit based on the executed instruction having a predicate to a value “false”; or
storing ones as the value in the locations of the first and second bits based on the executed instruction not having predicate.

4. The method according to claim 3, wherein the storing is performed in parallel with the executing.

5. The method according to claim 3, wherein the storing is performed simultaneously for instructions executed simultaneously.

6. The method according to claim 2, further comprising, after the executing, verifying a presence of the value in each of the memory zones, or detecting an absence of the value in one of the memory zones.

7. The method according to claim 2, wherein the storing comprises writing, in a memory word location comprising at least one of the memory zones, a word having, outside the at least one of the memory zones, a content of the memory word location before the writing.

8. The method according to claim 7, wherein the memory zones are located in at least two distinct memory banks, and the memory word location has least significant bits located in one of the two distinct memory banks, and most significant bits located in the other of the two distinct memory banks.

9. The method according to claim 1, wherein the memory zones are located in at least two distinct memory banks.

10. An integrated circuit comprising:
a device configured to select memory zones from respective positions of instructions of a program,
wherein the instructions each occupy one or more memory locations, and
wherein the memory zones comprise, for each memory location, a same number of bits.

11. The integrated circuit according to claim 10, further comprising the memory zones, wherein the integrated circuit is configured to execute the instructions.

12. The integrated circuit according to claim 11, wherein the integrated circuit is configured to:
couple to an outside memory disposed outside the integrated circuit; and
transmit contents of the memory zones to the outside memory.

13. The integrated circuit according to claim 11, wherein the device is configured to, for each executed instruction, store a value in one of the memory zones selected from the respective position of the executed instruction.

14. The integrated circuit according to claim 13, wherein each of the memory zones comprises at least one first bit and at least one second bit, the at least one first and at least one second bits comprising:
storing one as the value in a location of the first bit based on the executed instruction having a predicate to a value “true”;
storing one as the value in a location of the second bit based on the executed instruction having a predicate to a value “false”; or
storing ones as the value in the locations of the first and second bits based on the executed instruction not having predicate.

15. The integrated circuit according to claim 14, wherein the storing is performed in parallel with the executing.

16. The integrated circuit according to claim 14, wherein the storing is performed simultaneously for instructions executed simultaneously.

17. A device comprising:
an integrated circuit comprising memory zones, wherein the integrated circuit is configured to:
select the memory zones from respective positions of instructions of a program, the instructions each occupying one or more memory locations, wherein the memory zones comprise, for each memory location, a same number of bits, and wherein the integrated circuit is configured to execute the instructions; and
transmit contents of the memory zones to an outside memory coupled to the integrated circuit; and
the outside memory, configured to:
receive the contents of the memory zones; and
write the contents of the memory zones in the outside memory.

18. The device according to claim 17, wherein the integrated circuit is configured to, for each executed instruction, store a value in one of the memory zones selected from the respective position of the executed instruction.

19. The device according to claim 18, wherein each of the memory zones comprises at least one first bit and at least one second bit, the at least one first and at least one second bits comprising:
storing one as the value in a location of the first bit based on the executed instruction having a predicate to a value “true”;
storing one as the value in a location of the second bit based on the executed instruction having a predicate to a value “false”; or
storing ones as the value in the locations of the first and second bits based on the executed instruction not having predicate.

20. The device according to claim 19, wherein the device is configured to verify a presence of the value in the content of each of the memory zones, and/or detect an absence of the value in one of the memory zones.
